(19) United States
(12) Patent Application Publication
(10) Pub. No.: US 2013/0169688 A1
(43) Pub. Date: Jul. 4, 2013

(54) SYSTEM FOR ENLARGING BUTTONS ON THE TOUCH SCREEN

(71) Applicant: YANG-LIANG WU, Shenzhen City (CN)

(72) Inventor: YANG-LIANG WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/450,502

(22) Filed: Apr. 19, 2012

(30) Foreign Application Priority Data
Dec. 30, 2011 (CN) 201110452557.5

(51) Int. Cl. G09G 5/00

(52) U.S. Cl. 345/660

(57) ABSTRACT

A system includes a detecting module, a button determining module, and a button enlarging module. The button determining module controls an object detector to detect an object approaches the touch screen and generates a position signal associated with a position on the touch screen where the detected object approaches. The button determining module determines the position on the touch screen where the object approaches according to the position signal and determines one or more buttons designated at the determined position. The button enlarging module enlarges display size of the one or more buttons displayed at the determined position.

### BACKGROUND

1. Technical Field

The present disclosure relates to a system to enlarge display size of buttons displayed on a touch screen of an electronic device.

2. Description of Related Art

Due to the size of the touch screen being limited, more buttons displayed on the touch screen may make the size of each button smaller. The smaller displayed button may cause the user to wrong button.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a module diagram of a system for enlarging buttons displayed on a touch screen of an electronic device in accordance with an exemplary embodiment.

FIG. 2 is a block diagram of an electronic device which the system of FIG. 1 applied to.

FIG. 3 is a schematic diagram of the electronic device of FIG. 2 when the buttons displayed on the touch screen are not enlarged.

FIG. 4 is a schematic diagram of the electronic device of FIG. 2 when the buttons displayed on the touch screen are enlarged.

FIG. 5 is flowchart of a method for enlarging buttons displayed on a touch screen of the electronic device of FIG. 2.

### DETAILED DESCRIPTION

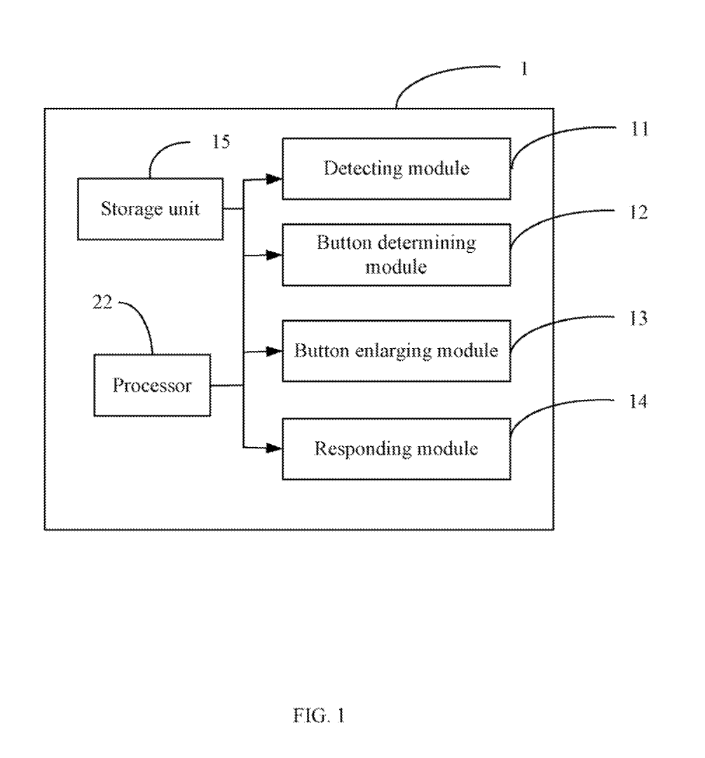

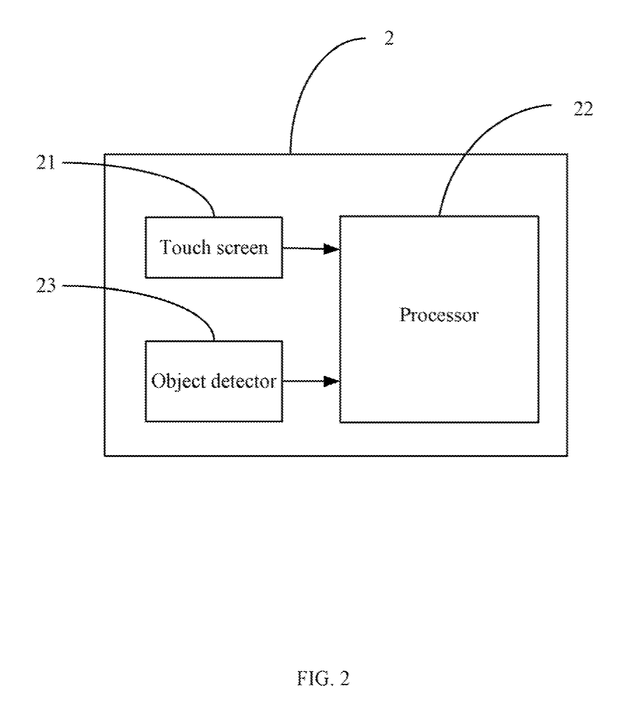

FIGS. 1 and 2, show a system 1 including a detecting module 11, a button determining module 12, a button enlarging module 13, a responding module 14, a storage unit 15, and a processor 22. The system 1 is applied to an electronic device 2. One or more programs of the above function modules may be stored in the storage unit 15 and executed by the processor 22. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

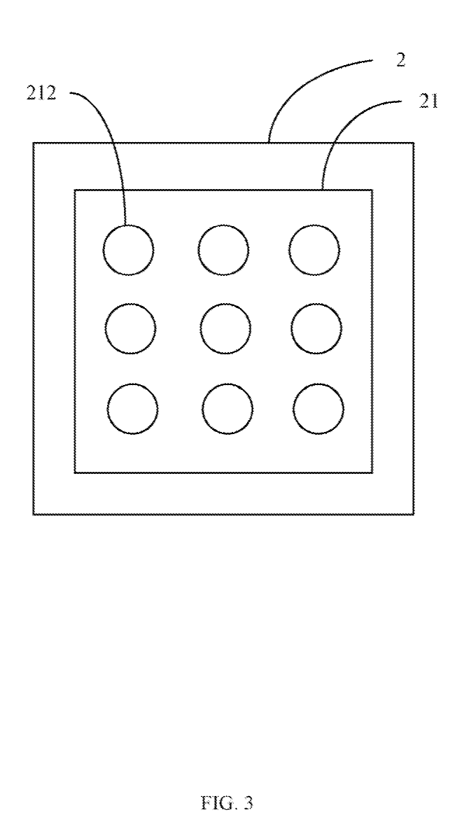

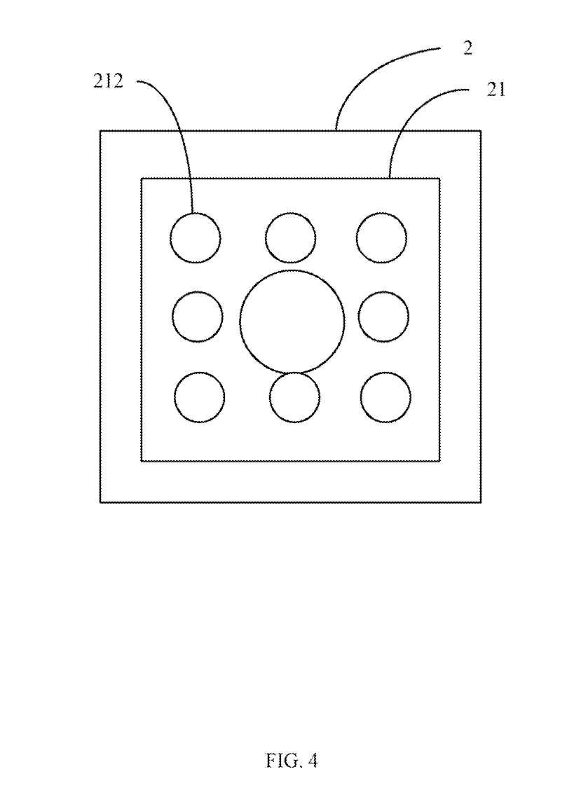

In the embodiment, the processor 22 is included in the electronic device 2. The electronic device 2 further includes a touch screen 21 and an object detector 23. As shown in FIG. 3, the touch screen 21 displays a number of buttons 212. The processor 22 implements the modules of the system 1 to enlarge display size of the buttons 212 of the touch screen 21 when an object approaches one or more displayed buttons on the touch screen 21. The detecting module 11 controls the object detector 23 to detect that an object approaches the touch screen 21 and generates a position signal associated with a position on the touch screen 21 where the detected object approaches. The button determining module 12 determines the position on the touch screen 11 where the object approaches according to the position signal and determines the one or more buttons displayed at the determined position. The button enlarging module 13 enlarges the determined one or more buttons displayed at the determined position (as shown in FIG. 4). The responding module 14 implements a predetermined function of one of the enlarged buttons in response to a touch operation.

In the embodiment, the object detector 12 is an infrared matrix which is formed by a number of pairs of infrared transmitter and infrared receiver defined around the touch screen 11 of the electronic device 2 and generates infrared rays in an X direction and a Y direction. When the object approaches a position of the touch screen 12, the object blocks some infrared rays of X direction and Y direction passing through the position. Thus, the position of the touch screen where the object approaches can be determined by the infrared rays that has been blocked by the object.

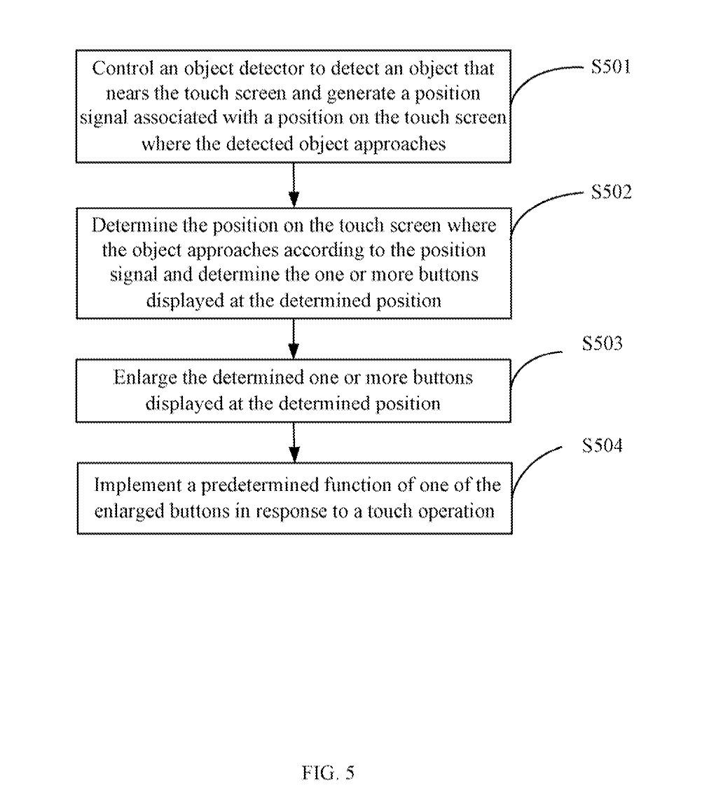

FIG. 5 is a flowchart of a method for enlarging the buttons 212 displayed on the touch screen 21.

In step S501, the detecting module 11 controls the object detector 23 to detect an object that approaches the touch screen 21 and generates a position signal associated with a position on the touch screen 21 where the detected object approaches.

In step S502, the button determining module 12 determines the position on the touch screen 11 where the object approaches according to the position signal and determines the one or more buttons displayed at the determined position.

In step S503, the button enlarging module 13 enlarges the determined one or more buttons displayed at the determined position (as shown in FIG. 4).

In step S504, the responding module 14 implements a predetermined function of one of the enlarged buttons in response to a touch operation.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A system for enlarging display size of one or more buttons displayed on a touch screen of an electronic device, comprising:
a processor;
a detecting module, executed by the processor, for controlling an object detector to detect an object approaching the touch screen and generates a position signal associated with a position on the touch screen where the detected object approaches;
a button determining module, executed by the processor, for determining the position on the touch screen where the object approaches according to the position signal and determining one or more buttons displayed at the determined position; and
a button enlarging module, executed by the processor, for enlarging display size of the determined one or more buttons displayed at the determined position.

2. The system as described in claim 1, further comprising a responding module performed by the processor for implementing a predetermined function of one of the enlarged buttons in response to a touch operation.

3. An electronic device comprising:
a touch screen displaying a plurality of buttons;
an object detector for detecting an object approaches the touch screen;
a processor comprising:
a detecting module for controlling an object detector to detect an object approaches the touch screen and generates a position signal associated with a position on the touch screen where the detected object approaches;
a button determining module for determining the position on the touch screen where the object approaches according to the position signal and determining one or more buttons displayed at the determined position; and
a button enlarging module for enlarging display size of the determined one or more buttons displayed at the determined position.

4. The electronic device as described in claim 3, wherein the processor further performs a responding module for implementing a predetermined function of one of the enlarged buttons in response to a touch operation.

5. The electronic device as described in claim 3, wherein the object detector is a infrared matrix which formed by a plurality of pairs of infrared transmitter and infrared receiver defined around the touch screen of the electronic device and generates infrared rays in an X direction and a Y direction.

6. A method for enlarging display size of one or more buttons displayed on a touch screen of an electronic device, comprising:
controlling an object detector to detect an object approaches the touch screen and generate a position signal associated with a position on the touch screen where the detected object approaches;
determining the position on the touch screen where the object approaches according to the position signal and determining one or more buttons displayed at the determined position;
enlarging display size of the determined one or more buttons displayed at the determined position.

7. The method as described in claim 6, further comprising: implementing a predetermined function of one of the enlarged buttons in response to a touch operation.

8. A non-transitory storage medium storing a set of instructions, the set of instructions capable of being executed by a processor to perform a method, the method comprising:
controlling an object detector to detect an object approaches the touch screen and generate a position signal associated with a position on the touch screen where the detected object approaches;
determining the position on the touch screen where the object approaches according to the position signal and determining one or more buttons displayed at the determined position;
enlarging display size of the determined one or more buttons displayed at the determined position.

9. The non-transitory storage medium as described in claim 8, wherein the method further comprises: implementing a predetermined function of one of the enlarged buttons in response to a touch operation.
